(19) United States
(12) Patent Application Publication
(10) Pub. No.: US 2020/0071977 A1
(43) Pub. Date: Mar. 5, 2020

(54) DOOR ASSEMBLY AND HINGE ASSEMBLY

(71) Applicant: PROMACH FILLING SYSTEMS, LLC, Corona, CA (US)

(72) Inventor: Cezary Mroz, Elkhorn, WI (US)

(21) Appl. No.: 16/115,782

(22) Filed: Aug. 29, 2018

(51) Int. Cl. E05D 15/48; E05D 5/14; E05D 7/00

(52) U.S. Cl. CPC E05D 15/48; E05D 5/14; E05Y 2900/608; E05D 2015/485; E05D 7/00

(57) ABSTRACT

A pivotal door assembly includes a door post and a door panel attached to the post via a hinge assembly. The hinge assembly includes a first partial hinge loop extending from the first hinge plate and partially around the door post, and a second partial hinge loop extending from the second hinge plate and partially around the door post. The first partial hinge loop and the second partial hinge loop together provide a clamping of the hinge assembly onto the door post. The first partial hinge loop and the second partial hinge loop slide circumferentially about the door post during pivotal movement of the door panel, and the door panel is pivotal by at least a circumferential amount that is sufficient to expose all hinge-aligned surface portions of the door post for cleaning during pivot. The hinge assembly may include a third partial hinge loop as well.

### TECHNICAL FIELD

This application relates generally to hinges and, more specifically, to a sanitary hinge assembly that provides for cleanability without hinge removal.

### BACKGROUND

In certain environments cleanability of equipment is important. For example, in the case of machinery utilized in the processing and manufacturing of foods or pharmaceuticals, cleanability is critical. Such machinery often utilizes movable doors, either on the machinery itself or on perimeter shielding/guarding of the machinery.

It would be desirable for such applications to provide a hinge assembly that enables cleaning without hinge removal.

### SUMMARY

In one aspect, a pivotal door assembly includes a door post and a door panel attached to the post via a hinge assembly. The hinge assembly includes a first hinge component having a first hinge plate connected to the door panel, the first hinge component including a first partial hinge loop extending from the first hinge plate and partially around the door post in a first circumferential direction; and a second hinge component having a second hinge plate connected to the door panel, the second hinge component including a second partial hinge loop extending from the second hinge plate and partially around the door post in a second circumferential direction, the second circumferential direction opposite the first circumferential direction.

In another aspect, a pivotal door assembly includes a door post and a door panel attached to the post via a hinge assembly. The hinge assembly includes a first partial hinge loop extending partially around the door post, and a second partial hinge loop extending partially around the door post. The first partial hinge loop and the second partial hinge loop together hold the hinge assembly onto the door post. The first partial hinge loop and the second partial hinge loop slide circumferentially about the door post during pivotal movement of the door panel, and a combined circumferential extent of the first partial hinge loop and the second partial hinge loop is less than three-hundred and forty degrees about door post.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of a door assembly;

FIG. 2 is partial perspective view of the door assembly;

FIGS. 3-5 are perspective views of a hinge assembly;

FIG. 6 is another partial perspective of the door assembly;

FIG. 7 is a partial top view of the door assembly;

FIG. 8 is another partial perspective of the door assembly;

FIG. 9 is a partial bottom view of the door assembly;

FIGS. 10-12 show another embodiment of a door hinge assembly.

### DETAILED DESCRIPTION

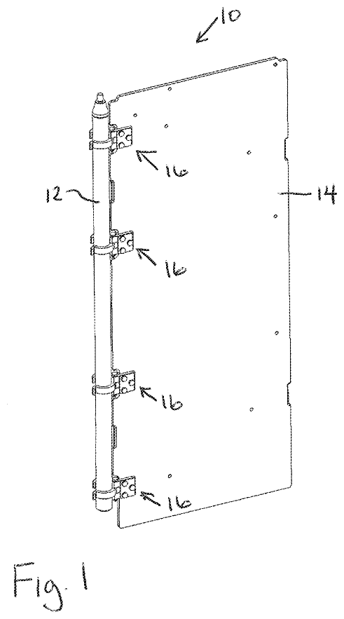

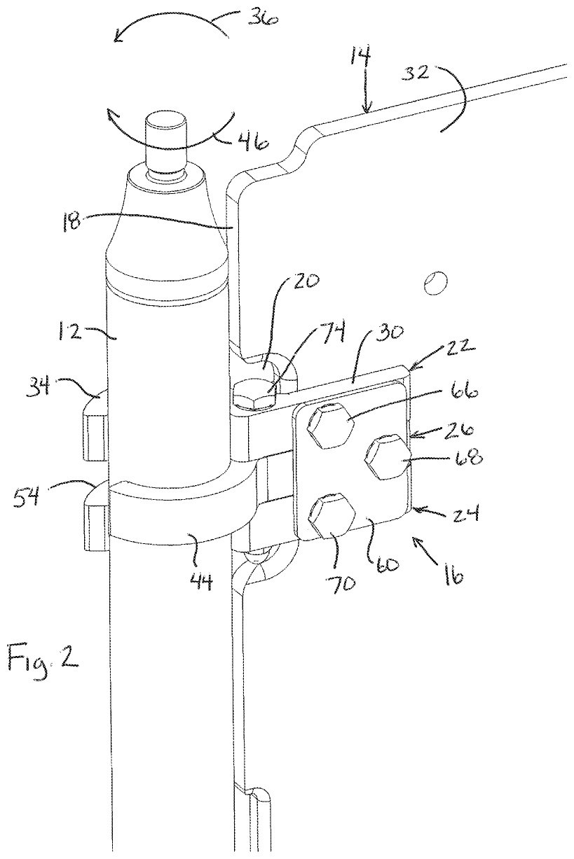

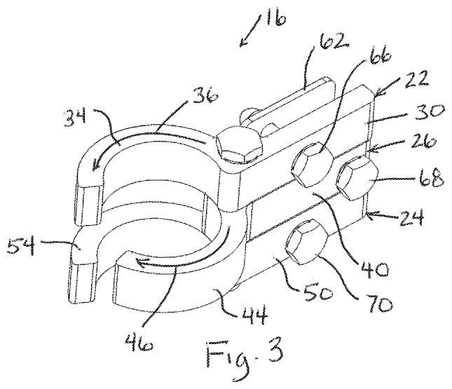

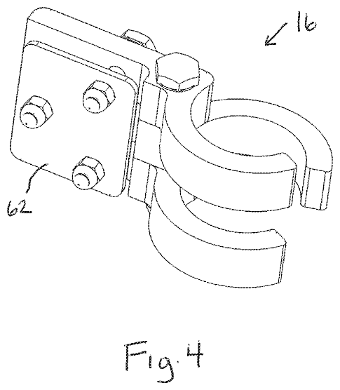

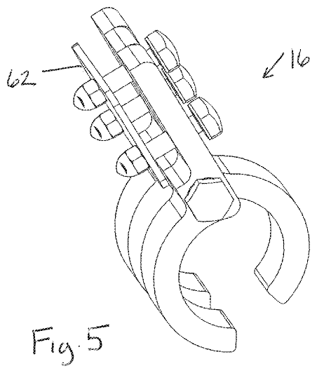

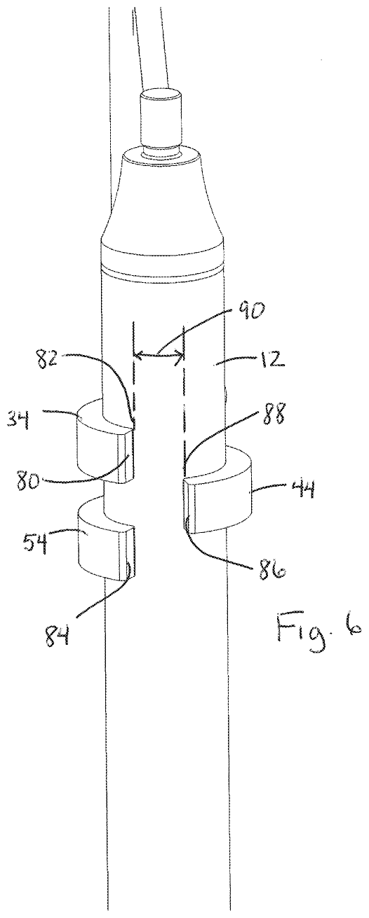

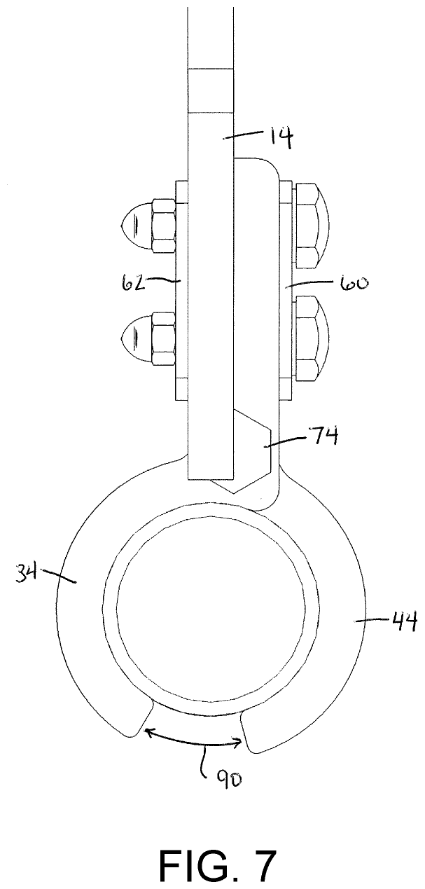

Referring to FIGS. 1-5, a pivotal door assembly 10 includes a door post 12 and a door panel 14 attached to the post via multiple hinge assemblies 16. The hinge assemblies are each mounted along one edge 18 of the door panel and, in the illustrated embodiment, the door panel edge 18 is defined with a recess 20 to accommodate each hinge assembly 16.

Each hinge assembly has a similar configuration, which is described below for a single hinge assembly. In particular, each hinge assembly 16 includes an upper hinge component 22, a lower hinge component 24 and a middle hinge component 26. Upper hinge component 22 includes hinge plate 30 connected at a side surface 32 of the door panel, and a partial hinge loop 34 extending from the hinge plate 30 and partially around the door post 12 in a circumferential direction 36. Middle hinge component 26 includes a hinge plate 40 connected at the side surface 32 of the door panel, and a partial hinge loop 44 extending from the hinge plate 40 and partially around the door post 12 in a circumferential direction 46, where circumferential direction 46 is opposite circumferential direction 36. Lower hinge component 22 includes a hinge plate 50 connected at the side surface 32 of the door panel, and a partial hinge loop 54 extending from the hinge plate 50 and partially around the door post 12 in the circumferential direction 36.

The hinge plates 30, 40 and 50 are adjacent each other on the side surface 32, vertically stacked. The hinge plates 30, 40, 50 are secured to the side surface 32 of the door panel by a clamp assembly that includes a clamp plate 60 at an external side of the hinge plates, and a clamp plate 62 at an opposite side surface 64 of the door panel 14. A fastener 66 passes through aligned openings in the clamp plate 60, hinge plate 30 and clamp plate 62. A fastener 68 passes through aligned openings in the clamp plate 60, the hinge plate 40 and clamp plate 62. A fastener 70 passes through aligned openings in the clamp plate 60, hinge plate 50 and clamp plate 62. Here, the fasteners take the form of bolts, with and cap nuts at the threaded end, and serving to squeeze the two clamp plates 60, 62 toward each other to stabilize the hinge assembly mount to the door panel. In addition, the hinge components are also connected together by a common pin 74 that extends vertically through aligned openings of the hinge components. Here, the common pin 74 also takes the form of a bolt, with a cap nut at the threaded end, to vertically squeeze the components together.

However, pin 74 does not act as a pivot point. Notably, wherein the partial hinge loops 34, 54 and partial hinge loop 44 together provide a clamping of the hinge assembly onto the door post 12, and the hinge loops can slide circumferentially about the door post 12 during pivotal movement of the door panel. The hinge components may be of a plastic material to facilitate such sliding relative to the post. The combined circumferential extent of the partial hinge loops 34, 54 and the partial hinge loop 44 is less than three-hundred and sixty degrees about door post. For example, the combined circumferential extent may be less than three-hundred and forty degrees, or less than three-hundred and twenty-five degrees.

Thus, in this hinge assembly configuration, a distal or free end 80 of partial hinge loop 34 terminates at a circumferential location 82, as does the distal or free end 84 of the partial hinge loop 54. A distal or free end 86 of the partial hinge loop 44 terminates at a circumferential location 88 that is circumferentially spaced apart from the circumferential location 82. The distal end 88 is circumferentially spaced apart from all portions of the partial hinge loops 34 and 54. The result is a vertically extending circumferential gap 90 between the distal portions of the partial hinge loops.

Moreover, the partial hinge loops 34, 44, and 54 slide circumferentially about the door post 12 during pivotal movement of the door panel, and the door panel is pivotal by at least a circumferential amount that is sufficient to expose all hinge-aligned surface portions of the door post for cleaning during pivot, resulting in a so-called sanitary hinge.

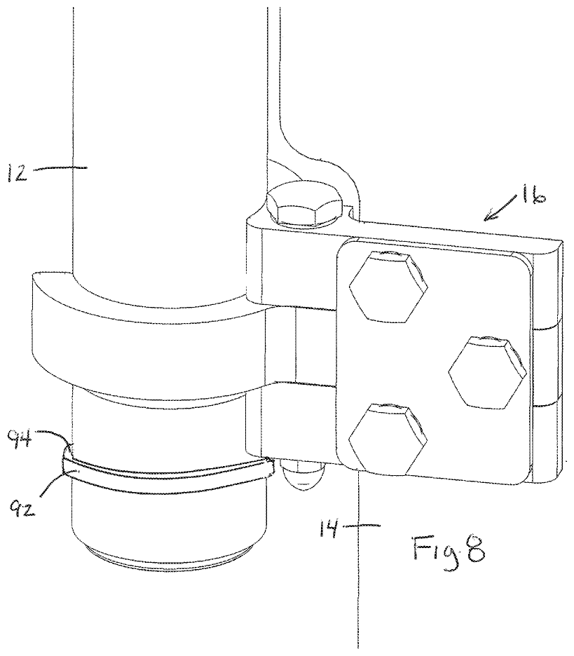

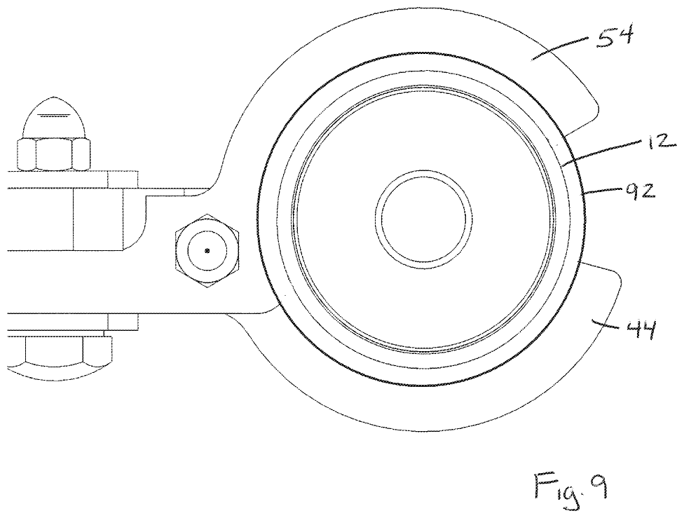

The partial hinge loops 34, 44 and 54 can also slide vertically along the door post 12. Which in some situations may also aid with cleaning (e.g., in the case of door panels that are not too heavy to lift slightly). As best seen in FIGS. 8 and 9, the door post 12 includes a collar 92 that defines a step 94 that engages part of at least one of the hinge assemblies to limit downward movement of the door panel and hinge assemblies 16 along the door post 12. Typically the collar 92 will be located toward the bottom of the post and associated with the lowermost hinge assembly, with the lower partial hinge loop 84 of the hinge assembly sliding atop the step 94 during pivotal movement of the door panel.

It is to be clearly understood that the above description is intended by way of illustration and example only, is not intended to be taken by way of limitation, and that other changes and modifications are possible.

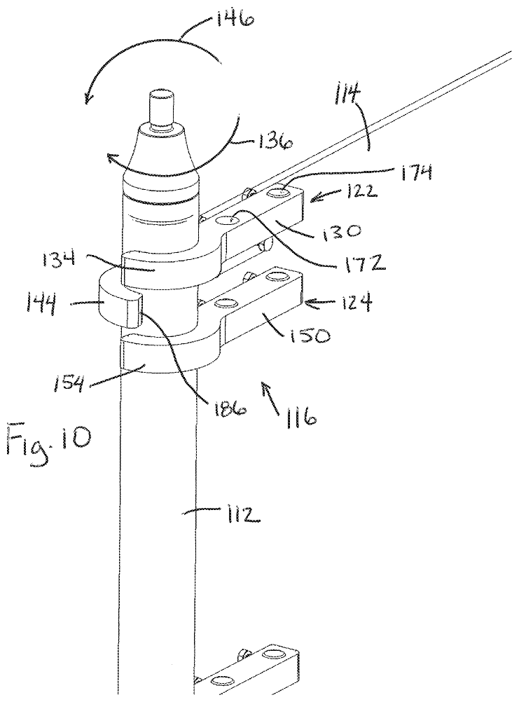

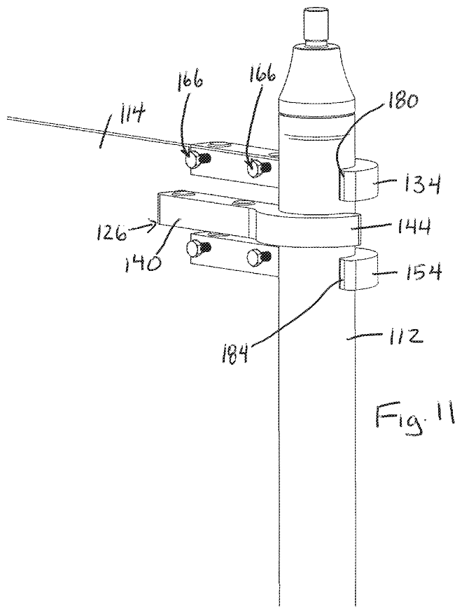

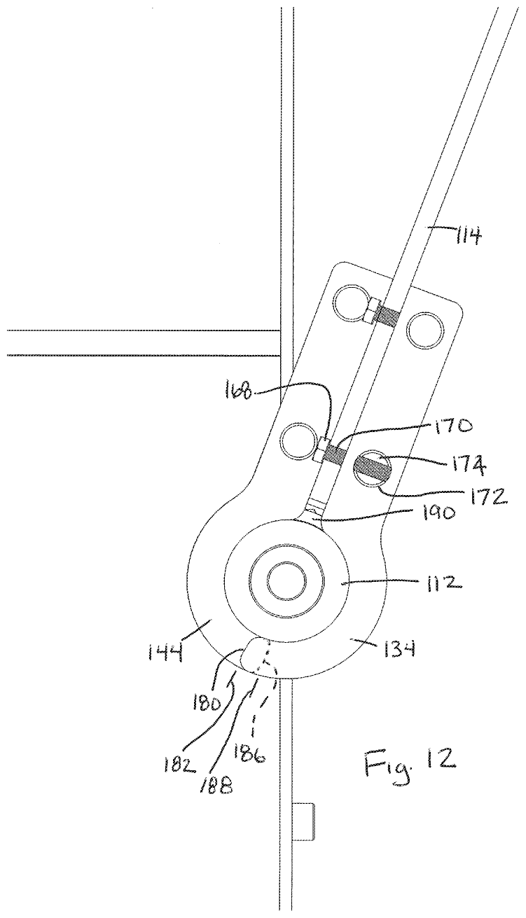

For example, while hinge assembly 16 has the hinge plate of each hinge component connected on a common side/face of the door panel, arrangements in which one or more hinge plates of a hinge assembly are on one side/face of the panel and one or more hinge plates of a hinge assembly are on the opposite side/face of the panel are possible. In this regard, reference is made to FIGS. 10-12 showing such an exemplary hinge assembly 116 mounting a door panel 114 to a door post 112. Three hinge components 122, 124 and 126 make up the hinge assembly 116, with the hinge plates 130 and 150 of components 122 and 124 mounted on one side surface of the door panel, and with hinge plate 140 of hinge component 126 mounted on the opposite side surface of the door panel. Upper hinge component 122 includes a partial hinge loop 134 extending from the hinge plate 130 and partially around the door post 112 in a circumferential direction 136. Middle hinge component 126 a partial hinge loop 144 extending from the hinge plate 140 and partially around the door post 112 in a circumferential direction 146, where circumferential direction 146 is opposite circumferential direction 136. Lower hinge component 122 includes a partial hinge loop 154 extending from the hinge plate 150 and partially around the door post 112 in the circumferential direction 136.

A distal or free end 180 of partial hinge loop 134 terminates at a circumferential location 182, as does the distal or free end 184 of the partial hinge loop 154. A distal or free end 186 of the partial hinge loop 144 terminates at a circumferential location 188 that is circumferentially spaced apart from the circumferential location 182. In this embodiment, the distal ends of the partial hinge loops 134 and 154 actually overlap slightly with the distal end of the partial hinge loop 144, and on the opposite side of the door post a small circumferential gap 190 is provided between the hinge components 122, 124 and the hinge component 126. Notwithstanding the overlap of the distal ends, the partial hinge loops 134, 154 and the partial hinge loop 144 slide circumferentially about the door post 112 during pivotal movement of the door panel 114, with the door panel 114 pivotal by at least a circumferential amount that is sufficient to expose all hinge-aligned surface portions of the door post 112 for cleaning during pivot.

As seen by representative discussion for hinge component 122, the hinge plate of a hinge component may be connected to the door panel 114 by one or more fasteners 166. Here, the fasteners 166 take the form of bolts having a head 168 on the side of the door panel opposite the hinge plate 130, with the threaded bolt shaft 170 passing through aligned openings in the door panel 114 and hinge plate 130. Where the hinge components are of molded plastic, the hinge plates may include vertical bores 172 that receive metal nuts 174 to engage with the threaded bolt shaft 170. A sealing cap 174 may be placed within each bore 172. In a door assembly including multiple hinge assemblies 116, one of the hinge assemblies may ride on a collar in a similar manner to that described above.

Other variations, modifications and embodiments are possible.

What is claimed is:

1. A pivotal door assembly, comprising:
a door post;
a door panel attached to the post via a hinge assembly, wherein the hinge assembly comprises:
a first hinge component having a first hinge plate connected tp the door panel, the first hinge component including a first partial hinge loop extending from the first hinge plate and partially around the door post in a first circumferential direction;
a second hinge component having a second hinge plate connected to the door panel, the second hinge component including a second partial hinge loop extending from the second hinge plate and partially around the door post in a second circumferential direction, the second circumferential direction opposite the first circumferential direction.

2. The pivotal door assembly of claim 1 wherein the first partial hinge loop and the second partial hinge loop together provide a clamping of the hinge assembly onto the door post, wherein the first partial hinge loop and the second partial hinge loop can slide circumferentially about the door post during pivotal movement of the door panel.

3. The pivotal door assembly of claim 2 wherein a combined circumferential extent of the first partial hinge loop and the second partial hinge loop is less than three-hundred and sixty degrees about door post.

4. The pivotal door assembly of claim 3 wherein the combined circumferential extent of the first partial hinge loop and the second partial hinge loop about the door post is less than three-hundred and forty degrees.

5. The pivotal door assembly of claim 1 wherein a distal end of the first partial hinge loop terminates at a first circumferential location and a distal end of the second partial hinge loop terminates at a second circumferential location that is circumferentially spaced apart from the first circumferential location.

6. The pivotal door assembly of claim 5 wherein the distal end of the second partial hinge loop is circumferentially spaced apart from all portions of the first partial hinge loop.

7. The pivotal door assembly of claim 5 wherein the distal end of the second partial hinge loop overlaps circumferentially with part of the first partial hinge loop.

8. The pivotal door assembly of claim 1 wherein the first partial hinge loop and the second partial hinge loop can slide circumferentially about the door post during pivotal movement of the door panel, and wherein the door panel is pivotal by at least a circumferential amount that is sufficient to expose all hinge-aligned surface portions of the door post for cleaning during pivot.

9. The pivotal door assembly of claim 1, further comprising:
the hinge assembly further including:
a third hinge component having a third hinge plate connected to the door panel, the third hinge component including a third partial hinge loop extending from the third hinge plate and partially around the door post in the first circumferential direction, wherein the first, second and third hinge plates are adjacent each other on the first side surface, and wherein the second hinge plate is positioned between the first hinge plate and the third hinge plate.

10. The pivotal door assembly of claim 9 wherein the first hinge plate, the second hinge plate, and the third hinge plate are secured to a first side surface of the door panel by a clamp assembly that includes:
a first clamp plate at an external side of the first, second and third hinge plates, a second clamp plate at a second side surface of the door panel,
a first fastener passing through the first clamp plate, the first hinge plate and the second clamp plate,
a second fastener passing through the first clamp plate, the second hinge plate and the second clamp plate,
a third fastener passing through the first clamp plate, the third hinge plate and the second clamp plate.

11. The pivotal door assembly of claim 9 wherein the first hinge plate and the third hinge plate are secured to the a first side surface of the door panel and the second hinge plate is secured to a second side surface of the door panel, wherein the second side surface is opposite the first side surface.

12. The pivotal door assembly of claim 1 wherein the first hinge component and the second hinge component are of plastic material.

13. The pivotal door assembly of claim 1 wherein the first partial hinge loop and the second partial hinge loop can slide vertically along the door post, wherein the door post includes a collar that defines a step that engages part of the hinge assembly to limit downward movement of the hinge assembly and the door panel along the door post.

14. The pivotal door assembly of claim 1 wherein hinge assembly is a first hinge assembly and the door panel is attached to the post via the first hinge assembly and at least one other hinge assembly having a configuration that is the same as a configuration of the first hinge assembly.

15. A pivotal door assembly, comprising:
a door post;
a door panel attached to the post via a hinge assembly, wherein the hinge assembly is attached to the door assembly and comprises:
a first partial hinge loop extending partially around the door post;
a second partial hinge loop extending partially around the door post;
wherein the first partial hinge loop and the second partial hinge loop together hold the hinge assembly onto the door post;
wherein the first partial hinge loop and the second partial hinge loop slide circumferentially about the door post during pivotal movement of the door panel, and wherein the door panel is pivotal by at least a circumferential amount that is sufficient to expose all hinge-aligned surface portions of the door post for cleaning during pivot.

16. The pivotal door assembly of claim 15 wherein the first partial hinge loop extends from a first hinge plate mounted on the door panel and the second partial hinge loop extends from a second hinge plate mounted on the door panel, wherein the first hinge plate and first partial hinge loop are located at a height along the door that is higher than a height at which the second hinge plate and the second partial hinge loop are located.

17. The pivotal door assembly of claim 16 wherein the first hinge plate is mounted on one side surface of the door panel and the second hinge plate is mounted on an opposite side surface of the door panel.
